(19) United States
(12) Patent Application Publication
(10) Pub. No.: US 2008/0150682 A1
(43) Pub. Date: Jun. 26, 2008

(54) VEHICLE ANTITHEFT DEVICE AND STRADDLE-TYPE VEHICLE HAVING VEHICLE ANTITHEFT DEVICE

(75) Inventor: Takahiro Shii, Shizuoka-ken (JP)

Correspondence Address: KNOBBE MARTENS OLSON & BEAR LLP, 2040 MAIN STREET, FOURTEENTH FLOOR, IRVINE, CA, 92614, US

(73) Assignee: Yamaha Motor Electronics Kabushiki Kaisha, Shizuoka-ken (JP)

(21) Appl. No.: 11/946,648

(22) Filed: Nov. 28, 2007

(30) Foreign Application Priority Data
Nov. 30, 2006 (JP) 2006-323662

(51) Int. Cl. G06F 7/04

(52) U.S. Cl. 340/5.22

(57) ABSTRACT

A vehicle antitheft device includes a first electric device signal detection circuit for detecting a first signal generated by the operational state of a first electric device and a second electric device signal detection circuit for detecting a second signal generated by the operational state of a second electric device. The first and second signals are combined to provide an input code. When the input code matches with a predetermined first ID authentication code, start-up of an engine of the vehicle is permitted. Accordingly, the vehicle antitheft device provides an increased number of codes for enabling or disabling an immobilizer function of the vehicle antitheft device, thereby effectively preventing theft of the vehicle.

This application is based upon and claims priority under 35 U.S.C. § 119 to Japanese patent application Serial No. 2006-323662, filed Nov. 30, 2006, the entire contents of which is hereby incorporated by reference.

### BACKGROUND OF THE INVENTIONS

1. Field of the Inventions

The present inventions relate to vehicle antitheft devices and, more specifically, to vehicle antitheft devices which utilize a switching operation (e.g., switching between operational states) of an electric device that can be equipped on, for example, a straddle-type vehicle.

2. Description of the Related Art

Conventionally, automobiles have been provided with vehicle antitheft devices as a way of preventing or deterring theft of the automobile. Such antitheft devices often employ a portable transponder incorporated in an exclusive ignition key (e.g., a key fob) that includes a specific identification code on an electronic chip. On the vehicle side, the antitheft device also has a specific identification code. The engine of the vehicle can start when it is verified (e.g., electronically verified) that both identification codes match.

An automobile having such a vehicle antitheft device is disclosed in Japanese Publication JP 8-30873, as follows: “A vehicle antitheft device in which when a signal from an ignition key 11 matches and an ignition switch is turned on, a variable code including a predetermined keyword is transmitted from an immobilizer ECU12 to an engine ECU13 so that the keyword is decrypted at the engine ECU13; and the engine is prohibited to start if the decrypted keyword is wrong.” According to JP 8-30873, “by providing the immobilizer ECU12 for unlocking the engine ECU13 by using the variable code, a vehicle antitheft device improving resistance to theft is provided.”

Another type of vehicle antitheft device designed for motorcycles does not use transponders as in the ignition key 11 described above. For example, Japanese Publication JP 3-668388 describes a “vehicle antitheft device in which an antitheft system does not actuate if an ignition key is taken out after executing an ON-OFF switching operation on a main switch in a predetermined pattern within a predetermined time, and the antitheft system actuates if the ignition key is taken out without executing any operation on the main switch.” As such, according to JP 3-668388, “an immobilizer function of a motorcycle can be disabled without using a remote control.”

However, the antitheft device of JP 8-30873 is constructed such that a transmitting/receiving function of a predetermined code needs to be separately provided to an ignition key 11, an immobilizer ECU12, and an engine ECU13. Therefore, a vehicle antitheft device has a complicated structure, resulting in higher manufacturing cost.

In addition, according to the device in JP 8-30873, if someone other than an owner of the automobile picks up or steals the ignition key 11, there is a possibility that he or she may steal the automobile only by inserting the ignition key 11 into a key hole in the automobile and turning it to allow the driving of the vehicle.

On the other hand, in the antitheft device of JP 3-668388, an immobilizer function is disabled by operating a switch of an electrical component of one system in a predetermined pattern. However, the switch of an electrical component of one system may have limited choice of predetermined patterns. Further, in the antitheft device of JP 3-668388, the predetermined pattern is so specific that someone other than an owner of a motorcycle may disable the immobilizer function with a key.

In order to avoid such a situation, the owner of the motorcycle may freely change how to disable the immobilizer function. However, if it is complicated to change how the immobilizer function is disabled, it will be burdensome to do.

### SUMMARY OF THE INVENTIONS

In view of the circumstances noted above, an aspect of at least one of the embodiments disclosed herein is to provide an improved vehicle antitheft device, whose structure is simple and whose manufacturing cost is inexpensive, which inhibits someone other than an owner of the vehicle from starting-up of the vehicle's engine and increases the number of ID authentication codes that can be used for starting the engine.

In accordance with an embodiment, a vehicle antitheft device is provided. The vehicle antitheft device comprises a plurality of electric devices associated with different systems on the vehicle, the operational state of the each of the plurality of electric devices being selectively changeable by the user of the vehicle. An operation signal detector receives a plurality of operation signals generated by changes in the operational states of the plurality of electric devices. An engine start-up controller determines whether an input code input by the user matches a previously set first ID authentication code, wherein the input code comprising a combination of the plurality of operation signals. The engine start-up controller controls an engine from a state in which the start-up of the engine is prohibited to a state in which the start-up of the engine is permitted when the input code matches the previously set first ID authentication code. Also, the engine start-up controller controls the engine to not switch from a state in which the start-up of the engine is prohibited to a state in which the start-up of the engine is permitted when the input code does not match the previously set first ID authentication code.

In accordance with another embodiment, a method for operating a vehicle antitheft device is provided. The method comprises actuating a main ignition switch from OFF to ON, changing the operational state of a plurality of electric devices of the vehicle to generate an input code, determining whether the input code matches a previously set ID authentication code, and controlling an engine of the vehicle to allow start-up of the engine when the input code matches the previously set ID authentication code.

### BRIEF DESCRIPTION OF THE DRAWINGS

These and other features, aspects and advantages of the present inventions will now be described in connection with preferred embodiments, in reference to the accompanying drawings. The illustrated embodiments, however, are merely examples and are not intended to limit the inventions. The drawings include the following 6 figures:

FIG. 1 is a schematic wiring diagram of one embodiment of a vehicle antitheft device.

FIG. 2 is a process chart illustrating an exemplary process of inputting a first ID authentication code when an engine according to the embodiment is switched from a state in which the engine is prohibited to be stated up to a state in which the engine is permitted to be started up.

FIG. 3 is a process chart illustrating how to operate a front brake switch and a rear brake switch when a second ID authentication code according to the embodiment is registered.

FIG. 4 is a process chart illustrating an exemplary process of operating a main switch, the front brake switch, and the rear brake switch and blinking states of a blinking light when a first ID authentication code according to the embodiment is registered.

FIG. 5 is a flow chart illustrating an exemplary process according to an embodiment in which an input code is verified with a newly registered first ID authentication code instead of the first ID authentication code once registered, including two ways of operation process, one is for a normal operation (S1 to S5) using the first ID authentication code and another is for an operation using the second ID authentication code (S21 to S24, S5).

FIG. 6 is a schematic wiring diagram illustrating a state in which an ID authentication function is provided in a CDI unit in the vehicle antitheft device according to an embodiment.

### DETAILED DESCRIPTION OF THE PREFERRED EMBODIMENT

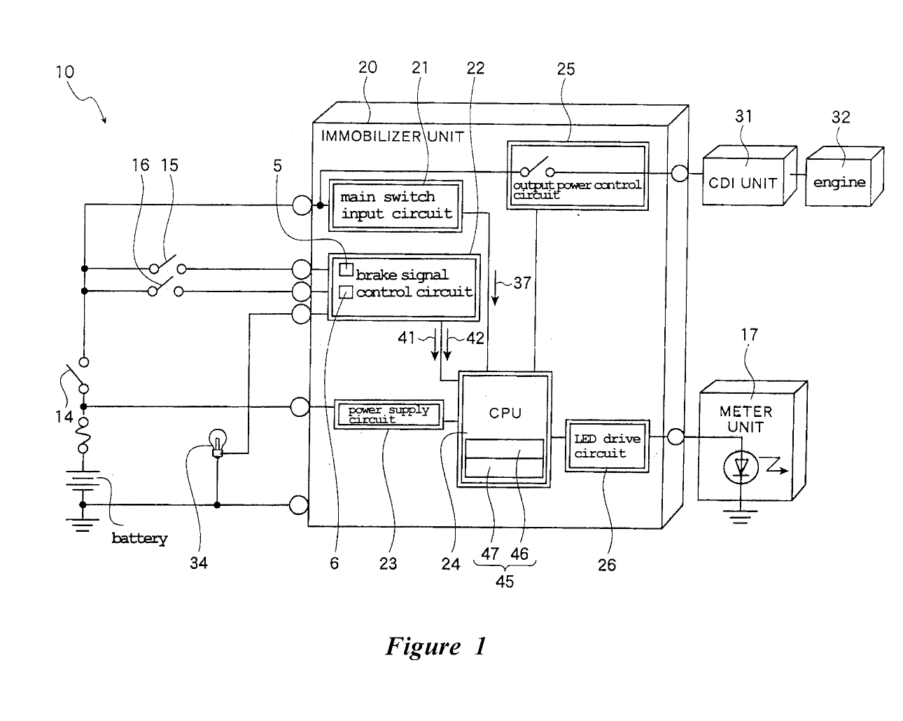

FIG. 1 shows an embodiment of a vehicle antitheft device 10, which can be mounted on a straddle-type vehicle (not shown), such as a motorcycle or a scooter. Straddle-type vehicles merely exemplify one type of environment in which the present inventions can be used. However, the various embodiments of the vehicle antitheft devices disclosed herein can be used with other types of land and water vehicles that benefit from antitheft features. Such applications will be apparent to those of ordinary skill in the art in view of the description herein. The present inventions are not limited to the embodiments described, which include the preferred embodiments, and the terminology used herein is not intended to limit the scope of the present inventions.

The vehicle antitheft device 10 can include a first electric device, such as a front brake switch 15, a second electric device, such as a rear brake switch 16, and a third electric device, such as a main switch 14. However, the first electric device can include devices other than the front brake switch 15. Likewise, the second electric device can include devices other than the rear brake switch 16. Also, the third electric device can include devices other than the main switch 14. Additionally, the electrical devices used in connection with the vehicle antitheft device 10 are not limited to the three noted above but can include more than three electrical devices.

The vehicle antitheft device 10 can also include an immobilizer unit 20, a CDI unit 31 connected to the immobilizer unit 20, and a meter unit 17. In addition, an engine 32 can be connected to the CDI unit 31. In some embodiments, these components can be electrically connected via a hard-wire connection. In other embodiments, at least some of these components can be connected via a wireless connection (e.g., Rf communication).

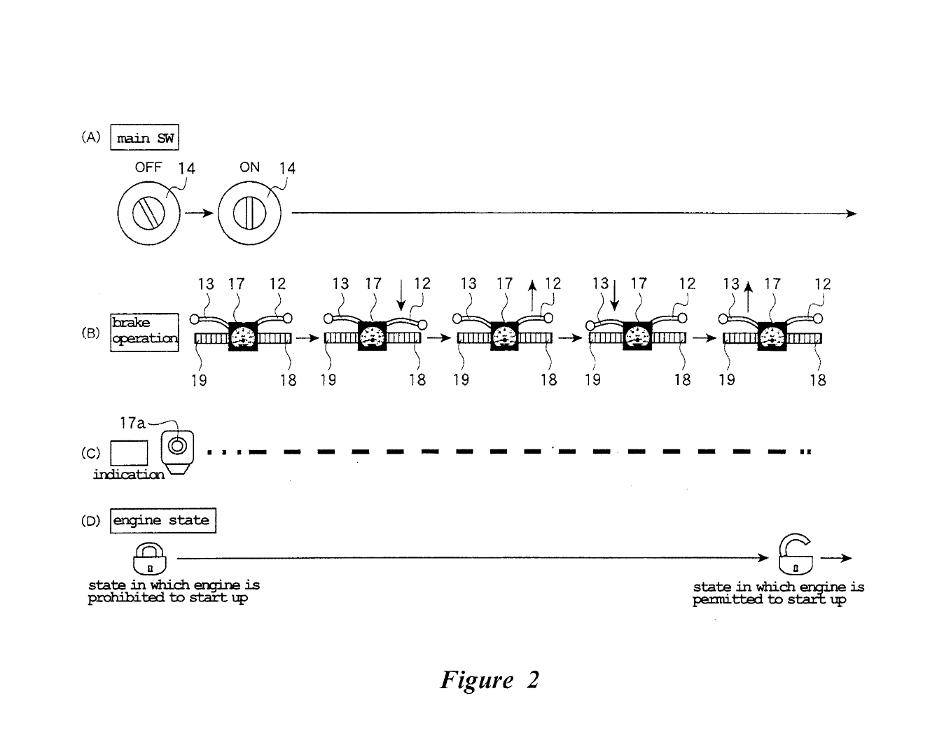

The front brake switch 15 (see FIG. 1), which can serve as a “first electric device” can be a switch for a brake for braking a front wheel (not shown) of the vehicle. However, other devices an also serve as a “first electric device”. The front brake switch 15 can be designed to be capable of changing operational states (e.g., switching ON or OFF) by, for example, gripping or releasing a front brake lever 12 (see FIG. 2 (B)). (Hereinafter, on means turning “ON” and off means turning “OFF.”). However, in some embodiments, the operational state of the front brake switch 15 can be changed in another manner. For example, the front brake lever 12 can be moved through a predetermined angle or rotation (e.g., a specified number of degrees), or it can be moved through a number of different positions measured in degrees of rotation, percentage of its maximum range of movement, or measured in other ways. These different modes of operation and/or movement can be applied to all of the devices described below as serving as one of the “electric devices”.

Similarly, the rear brake switch 16 (see FIG. 1), which can serve as a “second electric device”, can be a switch for a brake for braking a rear wheel (not shown) of the vehicle. However, other devices can also be used as a “second electric device”. The rear brake switch 16 can be designed to be capable of changing operational states (e.g., switching ON or OFF) by, for example, gripping or releasing a rear brake lever 13 (see FIG. 2 (B)). However, in another embodiment, the operational state of the rear brake switch 16 can be changed in another manner.

The main switch 14 (see FIG. 1), which can serve as a “third electric device”, can be designed to be capable of switching a main power supply device and an system between ON and OFF. However, other devices can also be used as a “third electric device”. The main power supply device can include a power storage device, such as a battery and the like, which can supply power to the main components of the vehicle by inserting a key into a key hole and turning it from a state in which the motorcycle is standing with its key taken out.

The front brake switch 15, the rear brake switch 16, and main switch 14 can be provided on the vehicle body of the straddle-type vehicle, such as a motorcycle (not shown), to be operated electrically and constructed in different systems, which can be separate systems in some embodiments, as shown in FIG. 1.

As shown in FIG. 1, the immobilizer unit 20 can include a main switch input circuit 21, which can serve as a “third operation signal detection means,” a brake signal control circuit 22, a power supply circuit 23, a CPU (central processing unit) 24 which can serve as an “engine start-up control means,” an output power control circuit 25, and an LED drive circuit 26.

A main switch operation signal 37, which can serve as a “third operation signal”, can be generated, for example, by a switching operation of the main switch 14. For example, the main switch input circuit 21 can be adapted to output the main switch operation signal 37 to the CPU (central processing unit) 24 when the main switch 14 is switched.

As shown in FIG. 1, the brake signal control circuit 22 can include a front wheel brake signal detection circuit 5 which can serve as a “first operation signal detection means” and a rear wheel brake signal detection circuit 6 which can serve as a “second operation signal detection means.” The front wheel brake signal detection circuit 5 can be adapted to detect a front wheel brake signal 41 as a “first operation signal,” which can be generated by a switching operation of the front brake switch 15.

In addition, the rear wheel brake signal detection circuit 6 which can serve as a “second generation signal detection means” can be adapted to detect a rear wheel brake signal 42 as a “second operation signal,” which can be generated by a switching operation of the rear brake switch 16. When either of the front wheel brake signal 41, which is generated by a switching operation of the front brake switch 15 and the rear wheel brake signal 42, which is generated by a switching operation of the rear brake switch 16 is input, the brake signal control circuit 22 blinks a brake lamp 34, which can serve as a “blinking means”, and outputs the front wheel brake signal 41 or the rear wheel brake signal 42 to the CPU (central processing unit 24.

Input to the CPU (central processing unit) 24, which can serve as “engine start-up control means”, can include the main switch operation signal 37 output from the main switch input circuit 21 and an input code 43 based on the front wheel brake signal 41 detected by the front wheel brake signal detection circuit 5 and the rear wheel brake signal 42 detected by the rear wheel brake signal detection circuit 6.

An ID authentication code 45 can include a first ID authentication code 46 and a second ID authentication code 47 used by a user of the straddle-type vehicle (e.g., motorcycle).

The first ID authentication code 46 can be used to switch the engine 32 from a state in which start-up of the engine 32 is prohibited to a state in which start-up of the engine 32 is permitted.

The second ID authentication code 47 can be used in case the previously registered first ID authentication code 46 is discarded. In some embodiments, the second ID authentication code 47 can be registered when a user purchases, for example, a motorcycle at a distributor.

During operation, when the input code 43 is input, the CPU (central processing unit) 24 can determine whether or not the input code 43 matches the preset first ID authentication code 46. When the codes match, the engine 32 can be switched from a state in which the start-up of the engine 32 is prohibited to a state in which the start-up of the engine 32 is permitted. When the codes do not match, the engine 32 can be prevented from switched from a state in which the start-up of the engine 32 is prohibited to a state in which the start-up of the engine 32 is permitted. That is, when the input code 43 matches the first ID authentication code 46, the CPU (central processing unit) 24 is adapted to drive the CDI unit 31 via the output power control circuit 25 to start up the engine 32, while when the input code 43 does not match the first ID authentication code 46, the CPU (central processing unit) 24 is adapted not to drive CDI unit 31 via the output power control circuit 25.

When the input code 43 is verified with a newly registered first ID authentication code 46 instead of the previously registered first ID authentication code 46 and the user remembers the first ID authentication code 46, the user can proceed with further processes. Although the description below describes changing the operational state of the front brake switch 15 and/or the rear brake switch 16 to input a first ID authentication code 46 as the input code 43, one of ordinary skill in the art will recognize that the first ID authentication code 46 may be generated by changing the operational state of devices other than the front and rear break switches 15, 16. Such devices can include, but are not limited to, the vehicle turn signals and other components that can be activated and deactivated to change the operational state thereof. Additionally, such devices can include devices that can be moved through a range of movement. As such, any associated sensor or detecting device can be configured to output proportional signals, e.g., signals that are proportional to a magnitude of movement of the device through its range of movement. With such proportional signals, the user can create ID authentication codes that require proportional states of such devices.

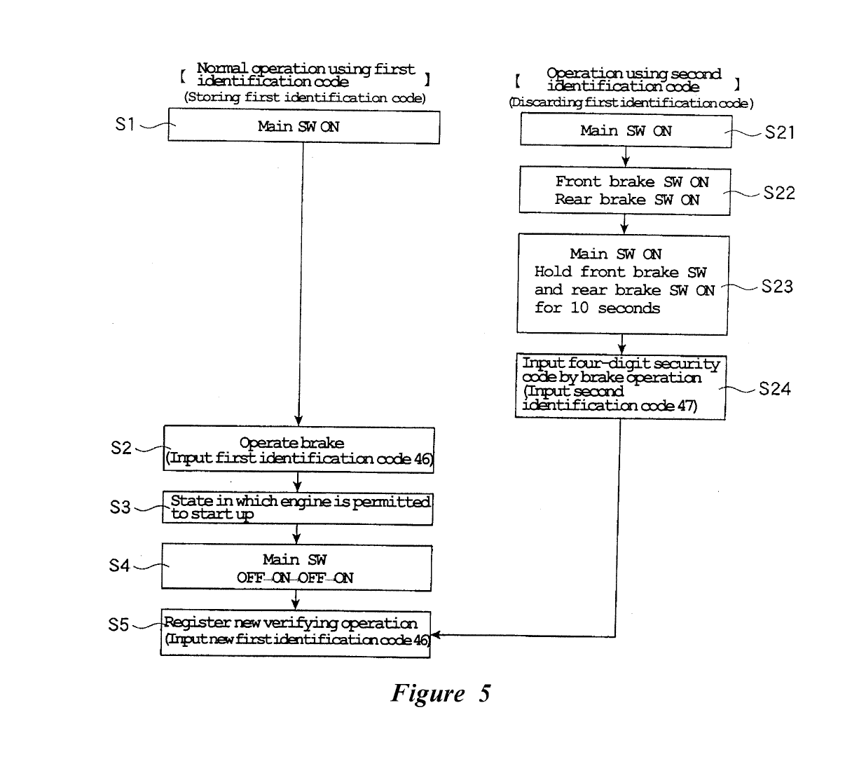

For example, first, the user can switch the main switch 14 once from OFF to ON (see FIG. 5. Step 1 (hereinafter, “step” is referred to as “S”)). Then, the user can change the operational state of the front brake switch 15 and/or the rear brake switch 16 in order to input the first ID authentication code 46 as the input code 43 (see S2 in FIG. 5). Next, the CPU (central processing unit) 24 can determine whether or not the input code 43 matches the first ID authentication code 46. When both codes match, the engine can be permitted to start (see S3 in FIG. 5). On the other hand, when the codes do not match, the engine can be prohibited from starting.

Then, the user can make a “predetermined operation” in which he or she can twice repeat the switching operation of the main switch 14 from OFF to ON after he or she has once moved the main switch 14 to OFF. This “predetermined operation” can be input as the main switch operation signal 37 (see S4 in FIG. 5). Thus, a registration mode of the new first ID authentication code 46 can start, in which registration of the new first ID authentication code 46 can be made and a new verifying operation can be registered (see S5 in FIG. 5).

When the input code 43 is verified with the new first ID authentication code 46 instead of the previously registered first ID authentication code 46 and the user has discarded the old first ID authentication code 46, the user can proceed with additional processes.

For example, firstly, the user can switch the main switch 14 once from OFF to ON (see S21 in FIG. 5). Then, the user can grip both of the front brake lever 12 and the rear brake lever 13 substantially simultaneously (see S22 in FIG. 5). Thus, all of the main switch 14, the front brake switch 15, and the rear brake switch 16 are kept ON from OFF for 10 seconds (see S23 in FIG. 5).

The CPU (central processing unit) 24 can determine whether or not the input code 43 matches with the second ID authentication code 47 (S24). If both codes have a match, the newly registered first ID authentication code 46 can be set instead of the previously registered first ID authentication code 46.

The power supply circuit 23 can supply power to the inside of the immobilizer unit 20 even when the main switch 14 is turned OFF. The CPU (central processing unit) 24, which is supplied with said power, operates a blinking lamp 17a (see FIG. 2(C)) in the meter unit 17 via the LED drive circuit 26 to prevent theft of the vehicle.

After a certain period of time has elapsed, the CPU (central processing unit) 24 can output a power supply stop signal to the power supply circuit 23 to stop power supply so that the battery charge of the battery is not drained. Then, actuation of the immobilizer unit 20 and blinking of the blinking lamp 17a can entirely stop. If a third person other than the user tries to start up the engine 32, the engine 32 cannot be started without inputting the first ID authentication code 46 after switching the main switch 14 to ON, even after the immobilizer unit 20 has been stopped, causing no problem.

The brake lamp 34 can be connected to the brake signal control circuit 22, and thus can be lit when the front brake switch 15 or the rear brake switch 16 is actuated to the ON or activated position.

### Switching Between A State In Which the Engine Is Prohibited From Starting And A State In Which the Engine Is Permitted To Start

With reference to FIG. 2, an exemplary process of switching from a state in which the start-up of the engine 32 is permitted to a state in which the start-up of the engine 32 is prohibited is described below. Additionally, switching from a state in which the start-up of the engine 32 is prohibited to a state in which the start-up of the engine 32 is permitted is also described below.

For example, when the user of the motorcycle wants the motorcycle to switch from a running state to a stopped state, he or she can switch the main switch 14 once from ON to OFF to switch the engine 32 from a state in which the engine 32 is permitted to be started up to a state in which the engine 32 is prohibited to be stated up to stop the engine 32.

When the main switch 14 is switched from OFF to ON again and if the elapsed time after the engine 32 has been stopped is within a predetermined time (set for 1 minute for example), the CPU (central processing unit) 24 in the immobilizer unit 20 controls the CDI unit 31 to start-up independent of inputting the first ID authentication code 46 so that the engine 32 is permitted to be started up.

However, when the main switch 14 is switched from OFF to ON after a predetermined time (1 minute, for example) has passed after the engine 32 has been stopped, the CPU (central processing unit) 24 in the immobilizer unit 20 does not issue the command to the CDI unit 31 to start up unless the first ID authentication code 46 is input. Accordingly, the engine 32 is inhibited from starting.

When the user of the motorcycle, or other straddle-type vehicle, wants the motorcycle to switch from a stopped state to a running state after a predetermined time has passed after the engine 32 has been stopped, he or she can switch the engine 32 from a state in which the start-up of the engine 32 is prohibited to a state in which the start-up of the engine 32 is permitted as described below. The user of the motorcycle first switches the main switch 14 once from OFF to ON, as shown in FIG. 2 (A). Then, an input mode of the first ID authentication code 46 starts, as shown in FIG. 2 (B), and the blinking lamp 17a rapidly blinks for 10 seconds, as shown in FIG. 2 (C). In some embodiments, the user of the motorcycle can be required to input the first ID authentication code 46 within 10 seconds in which the blinking lamp 17a rapidly blinks, as shown in FIGS. 2 (B) and (C). He or she can start up the CDI unit 31 to allow the engine 32 to be started up by performing a set of operations which, in the illustrated embodiment, includes gripping and releasing the front brake lever 12 once and gripping and releasing the rear brake lever 13 once.

However, if the input code 43 does not match the first ID authentication code 46 in the input mode described above, the CDI unit 31 does not start up, and therefore start-up of the engine 32 is prohibited.

### Registration of A Second ID Authentication Code

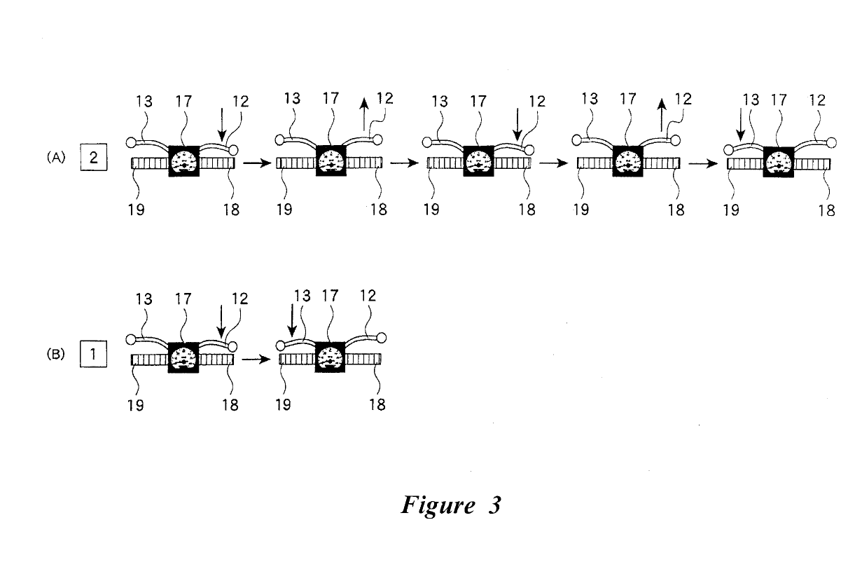

With reference to FIG. 3, the second ID authentication code 47 can be a code which can be registered when a user purchases a motorcycle at a distributor. A method of registering the second ID authentication code 47 is described below.

When the user of the motorcycle registers the second ID authentication code 47 at the time of purchasing the motorcycle at the distributor, he or she can first switch the main switch 14 once from OFF to ON and can grip the front brake lever 12 and the rear brake lever 13 simultaneously or substantially simultaneously. Then, he or she continues gripping for 10 seconds after the main switch 14, the front brake switch 15, and the rear brake switch 16 has been turned ON.

Thus, a registration mode of the second ID authentication code 47 starts. At this time, the blinking lamp 17a provided in the meter unit 17 slowly blinks for 30 seconds.

The user registers a predetermined four-digit number (for example, “2134” for description) during a slow blinking of the lamp for 30 seconds. In the illustrated embodiment, registration is performed as follows. First, gripping and releasing of the front brake lever 12 disposed in the vicinity of a right handlebar 18 is repeated twice and then gripping and releasing of the rear brake lever 13 disposed in the vicinity of a left handlebar 19 is performed once to determine the number “2” as shown in FIG. (3)(A). Next, gripping and releasing of the front brake lever 12 is performed once and then gripping and releasing of the rear brake lever 13 is performed once to determine the number “1” as shown in FIG. (3)(B). Next, gripping and releasing of the front brake lever 12 is repeated three times and then gripping and releasing of the rear brake lever 13 is performed once to determine the number “3.” Next, gripping and releasing of the front brake lever 12 is repeated four times and then gripping and releasing of the rear brake lever 13 is performed once to determine the number “4.” Thus, the input code 43 is set to “2134,” which is temporarily registered in the CPU (central processing unit) 24 as the second ID authentication code 47.

At this time, the blinking lamp 17a provided in the meter unit 17 starts to blink rapidly for 30 seconds. The user of the motorcycle operates the front brake lever 12 and the rear brake lever 13 in the same way as described above to finally register the “2134” as the second ID authentication code 47. Thus, the second ID authentication code 47 is finally registered in the CPU (central processing unit) 24.

The time for blinking the blinking lamp 17a is 30 seconds in case of Inputting the second ID authentication code 47. Time required for inputting the second ID authentication code 47 is taken into consideration for the 30 seconds.

### Registration And the Change of the First ID Authentication Code

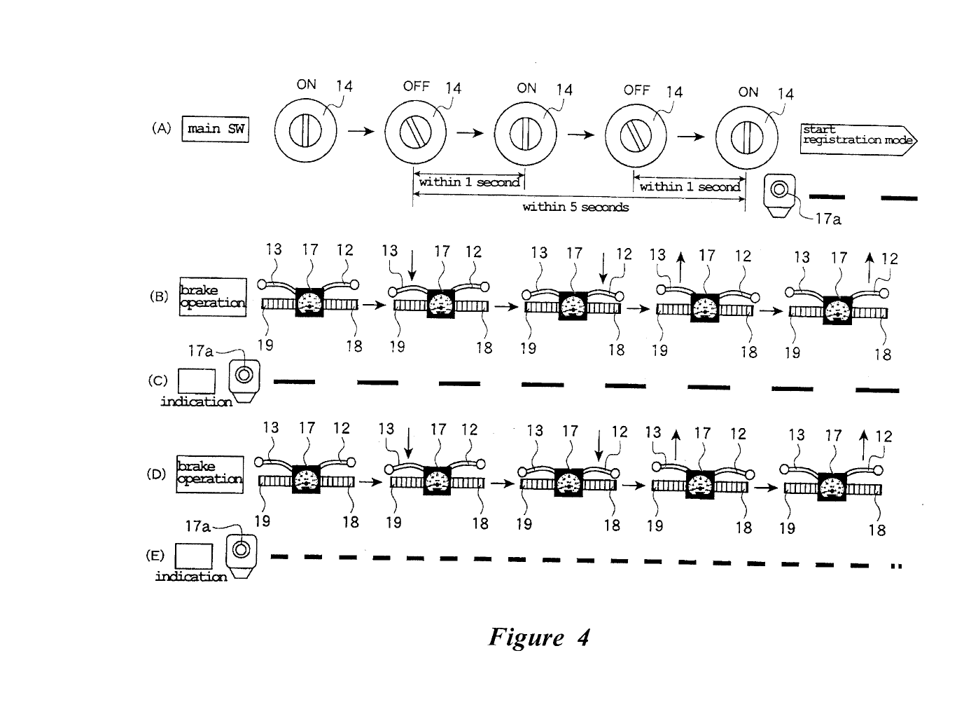

With reference to FIGS. 4 and 5, a method of identifying the input code 43 with a newly registered first ID authentication code 46 instead of with the previously-registered first ID authentication code 46 is described below.

The case in which the user of the motorcycle remembers the previously-registered first ID authentication code 46 is described below. First, when the user of the motorcycle switches the main switch 14 from OFF to ON as shown in FIG. 2 (A), the input mode of the first ID authentication code 46 (see FIG. 5. step 1 (hereinafter, “step” is referred to as “S”)) starts as shown in FIG. 2 (B) and the blinking lamp 17a rapidly blinks for 10 seconds, as shown in FIG. 2 (C). The user of the motorcycle is required to input the first ID authentication code 46 within 10 seconds in which the blinking lamp 17a keeps blinking rapidly. Accordingly, in the illustrated embodiment, he or she sequentially grips and releases the front brake lever 12 once and grips and releases the rear brake lever 13 once to input the first ID authentication code 46 as the input code 43 (see FIG. 5. S2). Then, the CPU (central processing unit) 24 determines whether or not the input code 43 matches the first ID authentication code 46. When both codes match, start-up of the engine 32 is permitted (see FIG. 5. S3). When both codes do not match, start-up of the engine 32 is prohibited.

After start-up of the engine 32 has been permitted, the user of the motorcycle turns off the main switch 14 once and then switches the main switch 14 twice from OFF to ON (see FIG. 5. S4). In this regard, the switching operation of the main switch 14 from OFF to ON is performed within 1 second. Additionally, switching the main switch 14 from OFF to ON twice is performed within 5 seconds. A temporary registration mode of the first ID authentication code 46 then starts and the blinking lamp 17a starts to blink slowly.

In some embodiments, the user of the motorcycle is required to temporarily register the first ID authentication code 46 within 10 seconds in which the blinking lamp 17a keeps blinking slowly. Accordingly, he or she can sequentially grip the rear brake lever 13 once, grip the front brake lever 12 once, release the rear brake lever 13 once, and release the front brake lever 12 once, as shown in FIG. 4 (B).

After 10 seconds has elapsed, a confirmation registration mode of the first ID authentication code 46 starts and the blinking lamp 17a starts to blink rapidly, as shown in FIG. 4 (E). The user of the motorcycle confirms and registers the new first ID authentication code 46 within 10 seconds. Accordingly, the user of the motorcycle sequentially grips the rear brake lever 13 once, grips the front brake lever 12 once, releases the rear brake lever 13 once, and releases the front brake lever 12 once, as shown in FIG. 4 (D). Thus, the new first ID authentication code 46 is verified as confirmed and registered, and the new verifying operation is registered (S5 in FIG. 5).

Next, in the case that the user of the motorcycle has discarded the first ID authentication code 46, he or she first switches the main switch 14 from OFF to ON (see S21 in FIG. 5). Then, the user can grip both of the front brake lever 12 and the rear brake lever 13 substantially simultaneously (see S22 in FIG. 5). The user further continues gripping the front brake lever 12 and the rear brake lever 13 for 10 seconds (see S23 in FIG. 5). Thus, the registration mode of the second ID authentication code 47 starts. The user can input a four-digit security code as the second ID authentication code 47 using the front brake lever 12 and the rear brake lever 13 (see S24 in FIG. 5).

Then, the next steps are the temporary registration mode and the confirmation registration mode of the first ID authentication code 46, in which the temporary registration and the confirmation registration can be made.

According to the vehicle antitheft device 10, switching of the front brake switch 15 and the rear brake switch 16 in two systems between ON and OFF within a predetermined time provides more numbers of the input code 43 and the first ID authentication code 46 compared with switching an electric device in one system between ON and OFF within a predetermined time, since the plural front wheel brake signal 41 and rear wheel brake signal 42 provide more combinations. Accordingly, the first ID authentication code 46 can be selected from such plentiful first ID authentication codes 46, thereby preventing theft of vehicle more effectively than conventional vehicle antitheft devices.

For example, an input code based on switching the electric device in one system between ON and OFF within a predetermined time allows inputting only one digit of the first ID authentication code 46. In order to input the first ID authentication code 46 in combination with at least two elements, a temporal element which makes input speed slower or faster or other elements can be used. Thus, some embodiments advantageously eliminate such temporal element or other elements. That is, when the temporal element is added, the operation becomes difficult for the user of the motorcycle. On the other hand, without the temporal element, the operation is advantageously easy for the user of the motorcycle. The advantage is the same as to the case of the second ID authentication code 47.

The owner of the vehicle independently determines the first ID authentication code 46 and the second ID authentication code 47. Therefore, someone other than the owner of the vehicle cannot switch from a state in which the start-up of the engine 32 is prohibited to a state in which the start-up of the engine 32 is permitted, unless he or she obtains the first ID authentication code 46 and the second ID authentication code 47 from the owner of the vehicle.

The owner of the vehicle can always use a favorite first ID authentication code 46 by registering a desirable type as the first ID authentication code 46. Also, the owner of the vehicle can further prevent theft of vehicle by replacing the first ID authentication code 46 with a desirable type.

Instead of the main switch operation signal 37, the front wheel brake signal 41, the rear wheel brake signal 42, or an input of an operation signal from other electric device may be alternated as a registration condition for the first ID authentication code 46.

Further, since plural electric devices conventionally included to separate systems on the vehicle are utilized, the vehicle antitheft device 10 can be downsized compared with a conventional vehicle antitheft device. Therefore, the structure can be more simple and the manufacturing cost can be less expensive. For example, operations by the front brake switch 15 and the rear brake switch 16, which generate the combination of the front wheel brake signal 41 and the rear wheel brake signal 42, form the input code 43. Accordingly, the user of the vehicle can easily input the input code 43. Specifically, the same brake lamp 34 is lit by operating both of the front brake lever 12 and the rear brake lever 13, thereby making it difficult for a third person to steal the ID authentication code 45.

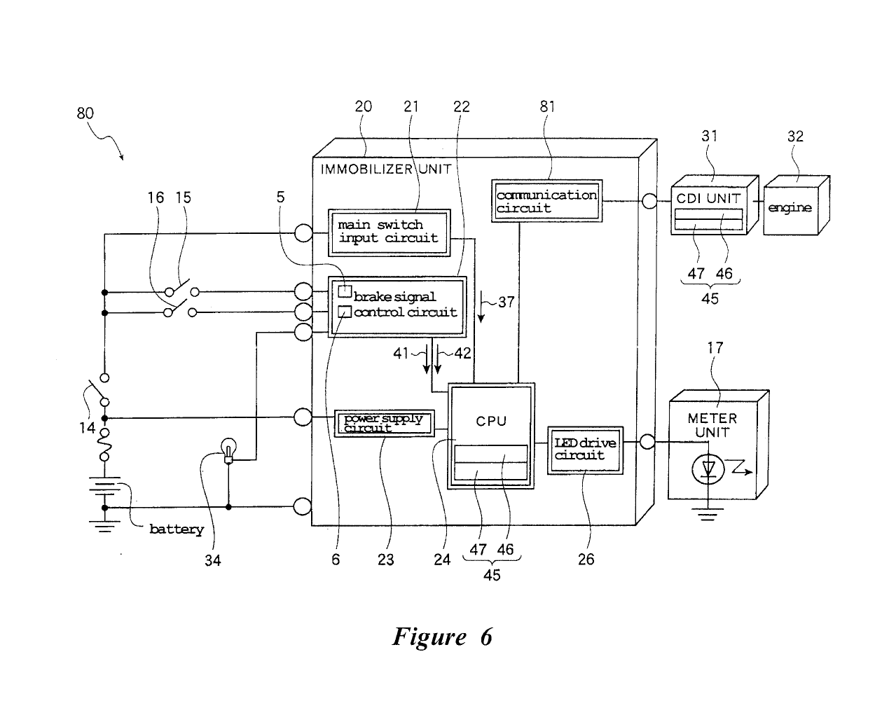

Although some embodiments of the vehicle antitheft device 10 do not include a function in which the ID authentication code is registered in the CDI unit 31 for identification, the present inventions are not limited thereto. As a vehicle antitheft device 80 shown in FIG. 6, the CDI unit 31 may also be configured to have a function in which the ID authentication code 45 is registered in the CDI unit 31 for ID authentication.

Further, although some embodiments of the vehicle antitheft device 10 are provided with the output power control circuit 25, the present inventions are not limited thereto. As the vehicle antitheft device 80 shown in FIG. 6, a communication circuit 81 may be provided instead of the output power control circuit 25.

In FIG. 6, components similar to those in the above embodiment of the vehicle antitheft device are denoted by the same numerals and their description is omitted.

In a vehicle antitheft device 80, an ID authentication code 45 can be registered in a CDI unit 31. The ID authentication code 45 includes a first ID authentication code 46 and a second ID authentication code 47. The control performed by the ID authentication code 45 in the CPU (central processing unit) 24 is also performed in the CDI unit 31 in the vehicle antitheft device 80.

According to the vehicle antitheft device 80, if someone other than the owner of the motorcycle tries to steal the motorcycle by replacing an immobilizer unit 20, he or she can not drive the motorcycle unless he or she verifies the first ID authentication code 46 in the CDI unit 31 based on the first ID authentication code 46 transmitted through the communication circuit 81. Therefore, theft prevention effect on the motorcycle can be further enhanced.

According to the embodiment of the vehicle antitheft device, although a vehicle such as a typical scooter in which a front brake lever 12 is disposed in the right handlebar 18 side and a rear brake lever 13 is disposed in the left handlebar 19 side as shown in FIGS. 2 to 4 is described, the present inventions are not limited thereto. For example, the present inventions can be applied to a motorcycle in which a front brake lever 12 is disposed in the right handlebar 18 side and a rear brake lever 13 is disposed in the footrest side for right foot.

In addition, though a front brake switch 15 is exemplified as a “first electric device,” a rear brake switch 16 as a “second electric device,” and a main switch 14 as a “third electric device” in the embodiments above, the present inventions are not limited thereto. The first electric device, the second electric device, or the third electric device may be any one of a front brake switch 15, a rear brake switch 16, a main switch 14, a right flasher switch (e.g., right turn signal), a left flasher switch (e.g., left turn signal), a hazard switch, a front light switch, a front light position switch, a high beam switch, an engine start switch, an engine stop switch, a horn switch, and any other component on the straddle-type vehicle that can be activated and deactivated by the user. Further, an input code 43 may be composed based on four or more operation signals associated with four or more switches to be determined whether or not it matches with an ID authentication code 45. For example, a construction in which an operation signal is generated by operating a first switch, an operation signal is generated by operating a second switch, an operation signal is generated by operating a third switch, an operation signal is generated by operating a forth switch, and all operations are sequentially made by one hand represents the above mentioned construction.

Further, in some embodiments, generating methods of the ID authentication code 45 can be different between the first ID authentication code 46 and the second ID authentication code 47. However, generating methods of the ID authentication code 45 can be the same between the both. There is another method for generating a four-digit input code 43 which may be composed by the combination of a front wheel brake signal 41 and a rear wheel brake signal 42. The front wheel brake signal 41 can be a “first operation signal” generated by a front brake switch 15 as a “first electric device.” The rear wheel brake signal 42 can be a “second operation signal” generated by a rear brake switch 16 as a “second electric device.” Four digits are composed in such a way that a first digit is determined by counting the number of the first digit with the front brake 12, a second digit is determined by counting the number of the second digit with the rear brake 13, a third digit is determined by counting the number of the third digit with the front brake 12, and a fourth digit is determined by counting the number of the fourth digit with the rear brake 13.

Further, in some embodiments, although one first ID authentication code 46 is set, the present inventions are not limited thereto. That is, a plurality of first ID authentication codes 46 can be preset. The CPU (central processing unit) 24 can input the input code 43 by combining the front wheel brake signal 41 and the rear wheel brake signal 42 and determine whether or not the input code matches any one of the plurality of preset first ID authentication codes 46. If there is a match, the engine 32 is switched from a state in which the start-up of the engine 32 is prohibited to a state in which the start-up of the engine 32 is permitted. When they do not match, the engine 32 is not switched from a state in which the start-up of the engine 32 is prohibited to a state in which the start-up of the engine 32 is permitted. This allows the user of the motorcycle to switch the engine 32 from a state in which the start-up of the engine 32 is prohibited to a state in which the start-up of the engine 32 is permitted as long as he or she remembers any one of the plurality of first ID authentication codes 46. Therefore, even if the user has discarded one of the first ID authentication codes 46, he or she can start the engine 32. Also, in the case that a plurality of users share one motorcycle, each user may have his or her own first ID authentication code 46 to switch the engine 32 from a state in which the start-up of the engine 32 is prohibited to a state in which the start-up of the engine 32 is permitted.

The registration of a plurality of first ID authentication codes 46, for example registering three first ID authentication codes 46 is described below.

As in a method in which one first ID authentication code 46 is registered as described above, the main switch 14 is switched once from ON to OFF and then the main switch 14 is switched from OFF to ON twice. Subsequently, a first new first ID authentication code 46 is registered. Then, a second new first ID authentication code 46 is registered by operating the main switch 14 as described above, and a third new first ID authentication code 46 is further registered by operating the main switch 14 as described above. When a fourth new first ID authentication code 46 is registered by operating the main switch 14 as described above, the first new first ID authentication code 46 is automatically deleted and the new fourth first ID authentication code 46 is registered since only three first ID authentication codes 46 are registered in some embodiments of the vehicle antitheft device. In the above example, the number of the first ID authentication codes 46 is described as three. However, fewer or more first ID authentication codes 46 (e.g., two or four authentication codes) may be utilized in the same way as long as the number of first ID authentication code 46 is plural.

In some embodiments, when the first ID authentication code 46 is input, the change in operation state (e.g., OFF-to-ON operation) of the front brake switch 15 and the rear brake switch 16 are recognized as the front wheel brake signal 41 and the rear wheel brake signal 42, respectively. Also, when the second ID authentication code 47 is input, only the OFF-to-ON operation of the front brake switch 15 and the rear brake switch 16 is recognized as the front wheel brake signal 41 and the rear wheel brake signal 42. However, the present inventions are not limited thereto. That is, when the first ID authentication code 46 or the second ID authentication code 47 is input, the switching operation between operation states of the front brake switch 15 and the rear brake switch 16 can be recognized by three ways. “only OFF-to-ON operation,” “only ON-to-OFF operation” and “both of ON-to-OFF operation and OFF-to-ON operation.” Either way may be recognized as the front wheel brake signal 41 and the rear wheel brake signal 42.

Further, the “straddle-type vehicle” can include a scooter, motorcycle, three-wheeled motorized vehicle, four-wheeled motorized vehicle and so on, as described above.

According to at least some of the embodiments above, the input code for the vehicle antitheft device is composed by combining the plurality of operation signals generated by changing the operational state (e.g., switching ON-OFF) of the plurality of electric devices, and inputting the operation signals to the engine start-up control means. The engine start-up control means verifies the input code with the first ID authentication code. When both codes match, the engine start-up control means switches the engine from a state in which the start-up of the engine is prohibited to a state in which the start-up of the engine is permitted. Alternatively, when both codes do not match, the engine start-up control means does not switch the engine from a state in which the start-up of the engine is prohibited to a state in which the start-up of the engine is permitted. The changing in the operational state of the electric devices in two separate systems within a predetermined time advantageously provides more signal combinations and therefore increases the numbers of the input code and the first ID authentication code compared with a device where the switching operation of the electric device between ON and OFF in one system within a predetermined time. Accordingly, the first ID authentication code can be selected from such plentiful codes, thereby preventing theft of vehicle more effectively than before.

Specifically, an input code based on switching electric device between ON and OFF in one system within a predetermined time allows inputting only one element of the first ID authentication code. In order to inputting the first ID authentication code in combination with two or more elements, a temporal element which makes input speed slower or faster or other elements are needed. Thus, some embodiments can advantageously eliminate such temporal element or other elements.

Additionally, as noted above, when the operation signal is input in a predetermined pattern after the engine is switched to a state in which the start-up of the engine is permitted, the engine start-up control means registers the desirable first ID authentication code by inputting the input code within a predetermined time. When the operation signal is input in a pattern other than the predetermined pattern, the engine start-up control means does not register the desirable first ID authentication code. Accordingly, an owner of a vehicle can always use a favorite first ID authentication code by registering a desirable type as the first ID authentication code. Also, the owner of the vehicle can further prevent theft of vehicle by occasionally replacing the first ID authentication code with a desirable type.

Also, the engine start-up control means registers the desirable first ID authentication code when the engine start-up control means determines that the input code input within a predetermined time after the predetermined operation matches the second ID authentication code. The engine start-up control means does not register the desirable first ID authentication code when the engine start-up control means determines that the input code does not match the second ID authentication code. Therefore, if the owner of the vehicle has discarded the first ID authentication code and cannot switch the engine from a state in which the start-up of the engine is prohibited to a state in which the start-up of the engine is permitted, he or she can obtain a new first ID authentication code by inputting the second ID authentication code to register a desirable first ID authentication code, thereby being able to switch the engine from a state in which the start-up of the engine is prohibited to a state in which the start-up of the engine is permitted.

In some embodiments, a plurality of first ID authentication codes can be set. When the input code is input, the engine start-up control means switches the engine from a state in which the start-up of the engine is prohibited to a state in which the start-up of the engine is permitted when the engine start-up control means determines that the input code matches any one of the preset plural first ID authentication codes. Alternatively, the engine start-up control means does not switch the engine from a state in which the start-up of the engine is prohibited to a state in which the start-up of the engine is permitted when the engine start-up control means determines that the input code does not match any one of the preset plurality of first ID authentication codes. Therefore, in the case that a plurality of users share one motorcycle, each user may have his or her own first ID authentication code to switch the engine from a state in which the start-up of the engine is prohibited to a state in which the start-up of the engine is permitted.

Since a plurality of electric devices are conventionally included to separate systems on the vehicle, the vehicle antitheft device can be downsized compared with a conventional vehicle antitheft device. Therefore, the structure becomes simple and the manufacturing cost becomes inexpensive. For example, operations by the front brake switch and the rear brake switch, which generate the combination of the first operation signal and the second operation signal, form the input code. Accordingly, the user of the vehicle can easily input the input code.

Although the present inventions have been disclosed in the context of a certain preferred embodiments and examples, it will be understood by those skilled in the art that the present inventions extend beyond the specifically disclosed embodiments to other alternative embodiments and/or uses of the inventions and obvious modifications and equivalents thereof. In addition, while a number of variations of the inventions have been shown and described in detail, other modifications, which are within the scope of the inventions. will be readily apparent to those of skill in the art based upon this disclosure. It is also contemplated that various combinations or subcombinations of the specific features and aspects of the embodiments may be made and still fall within one or more of the inventions. Accordingly, it should be understood that various features and aspects of the disclosed embodiments can be combine with or substituted for one another in order to form varying modes of the disclosed inventions. Thus, it is intended that the scope of the present inventions herein disclosed should not be limited by the particular disclosed embodiments described above.

What is claimed is:

1. A vehicle antitheft device, comprising:
a plurality of electric devices associated with different systems on the vehicle, the operational state of the each of the plurality of electric devices being selectively changeable by the user of the vehicle;
an operation signal detector configured to receive a plurality of operation signals generated by changes in the operational states of the plurality of electric devices; and
an engine start-up controller configured to determine whether an input code input by the user matches a previously set first ID authentication code, the input code comprising a combination of the plurality of operation signals, the engine start-up controller configured to control an engine from a state in which the start-up of the engine is prohibited to a state in which the start-up of the engine is permitted when the input code matches the previously set first ID authentication code, the engine start-up controller further configured to control the engine to not switch from a state in which the start-up of the engine is prohibited to a state in which the start-up of the engine is permitted when the input code does not match the previously set first ID authentication code.

2. The vehicle antitheft device of claim 1, wherein the plurality of electric devices comprises a first electric device and a second electric device, the plurality of operation signals comprise a first operation signal generated by an ON-OFF switching operation of the first electric device and a second operation signal generated by an ON-OFF switching operation of the second electric device, the operation signal detector comprising a first operation signal detector for detecting the first operation signal and a second operation signal detector for detecting the second operation signal, the input code composed by combining the first operation signal and the second operation signal.

3. The vehicle antitheft device of claim 2, wherein a second ID authentication code registered by combining the first operation signal and the second operation signal is set in addition to a desired first ID authentication code, the engine start-up controller registering the desired first ID authentication code when the engine start-up controller determines that the input code input within a predetermined time after a predetermined operation matches the second ID authentication code, and wherein the engine start-up controller does not register the desired first ID authentication code when the engine start-up controller determines that the input code does not match the second ID authentication code.

4. The vehicle antitheft device of claim 2, wherein the first electric device or the second electric device is chosen from the group consisting of: a front brake switch, a rear brake switch, a main switch, a right flasher switch, a left flasher switch, a hazard switch, a front light switch, a front light position switch, a high beam switch, an engine start switch, an engine stop switch, and a horn switch.

5. The vehicle antitheft device of claim 1, wherein when the operation signals generated by changing the operational state of the plurality of electric devices are input in a predetermined pattern within a predetermined time after the engine is switched to a state in which start-up of the engine is permitted, the engine start-up controller registers the input code corresponding to said predetermined pattern as a desired first ID authentication code, and when the operation signal is input in a pattern other than the predetermined pattern, the engine start-up controller does not register the desired first ID authentication code.

6. The vehicle antitheft device of claim 1 to 3, wherein the previously set first ID authentication code comprises a previously set plurality of first ID authentication codes, the engine start-up controller configured to control the engine from a state in which start-up of the engine is prohibited to a state in which start-up of the engine is permitted when the engine start-up controller determines that the input code matches any one of the previously set plurality of first ID authentication codes, and wherein the engine start-up controller does not switch the engine from a state in which start-up of the engine is prohibited to a state in which start-up of the engine is permitted when the engine start-up controller determines that the input code does not match at least one of the previously set plurality of first ID authentication codes.

7. The vehicle antitheft device of claim 1, wherein the vehicle is a straddle-type vehicle.

8. A method for operating a vehicle antitheft device, comprising:
actuating a main ignition switch from OFF to ON;
changing the operational state of a plurality of electric devices of the vehicle to generate an input code;
determining whether the input code matches a previously set ID authentication code; and
controlling an engine of the vehicle to allow start-up of the engine when the input code matches the previously set ID authentication code.

9. The method of claim 8, further comprising controlling the engine of the vehicle to prohibit start-up of the engine when the input code does not match the previously set ID authentication code.

10. The method of claim 8, further comprising:
actuating the main switch from OFF to ON a predetermined number of times; and
registering a new ID authentication code by changing the operational state of the plurality of electric devices of the vehicle to generate an input code corresponding to the new ID authentication code.

11. The method of claim 10, further comprising:
actuating the main switch from OFF to ON;
gripping the front and rear brake levers of the vehicle substantially simultaneously;
maintaining the actuation of the main switch and front and rear brake levers for a period of ten seconds;
changing the operational state of the plurality of electric devices to generate a second input code;
determining whether the second input code matches a preset second ID authentication code; and
setting the newly registered ID authentication code instead of the previously set ID authentication code when the second input code matches the preset second ID authentication code.

12. The method of claim 8, wherein changing the operational state of a plurality of electric devices comprises activating and/or deactivating at least two electric devices chosen from the group consisting of: a front brake switch, a rear brake switch, a main ignition switch, a right turn signal switch, a left turn signal switch, a hazard signal switch, a front light switch, a front light position switch, a high beam switch, an engine start switch, an engine stop switch, and a horn switch.

13. The method of claim 12, wherein changing the operational state of a plurality of electric devices comprises gripping and/or releasing a front brake lever and a rear brake lever.
